(19) United States
(12) Patent Application Publication
(10) Pub. No.: US 2009/0040353 A1
(43) Pub. Date: Feb. 12, 2009

(54) IMAGING APPARATUS AND METHOD OF DRIVING SOLID-STATE IMAGING DEVICE

(76) Inventor: Takeshi YAMAMOTO, Kurokawa-gun (JP)

Correspondence Address: BIRCH STEWART KOLASCH & BIRCH, PO BOX 747, FALLS CHURCH, VA, 22040-0747, US

(21) Appl. No.: 12/184,787

(22) Filed: Aug. 1, 2008

(30) Foreign Application Priority Data
Aug. 10, 2007 (JP) P2007-209021

(51) Int. Cl. H04N 5/335

(52) U.S. Cl. 348/308

(57) ABSTRACT

A solid-state imaging device includes plural color detection pixels (R, G, B) and plural luminance detection pixels (W). The color detection pixels (R, G, B) and the luminance detection pixels (W) are mixed and arranged in a two-dimensional array on a surface of a semiconductor substrate. The solid state imaging device is configured to read detection signals of the color detection pixels (R, G, B) and detection signals of the luminance detection pixels (W) independently. In driving of the solid-state imaging device, a first time period from a time when the color detection pixels (R, G, B) start to be exposed to a time when the detection signals are read and a second time period from a time when the luminance detection pixels (W) start to be exposed to a time when the detection signals are read are controlled independently.

### CROSS-REFERENCE TO RELATED APPLICATIONS

This application is based upon and claims the benefit of priority from the Japanese Patent Application No. 2007-209021 filed on Aug. 10, 2007, the entire contents of which are incorporated herein by reference.

### BACKGROUND OF THE INVENTION

1. Technical Field

The invention relates to a method of driving a solid-state imaging device, in which one half of a plurality of pixels formed on a surface of a semiconductor substrate in a two-dimensional array are luminance detection pixels, and the remaining half are color detection pixels, and relates to an imaging apparatus mounted with the solid-state imaging device.

2. Description of the Related Art

A solid-state imaging device for capturing a color image has a structure that any of red (R), green (G), and blue (B) color filters is laminated on each of a plurality of pixels formed on a surface of a semiconductor substrate in a two-dimensional array. In this case, each pixel only uses approximately one third of incident light, and color information is detected while sacrificing photodetection sensitivity.

In recent years, it has become common that a solid-state imaging device mounted on a digital camera has several million of pixels. Accordingly, the capacity of each pixel becomes small, and the photodetection sensitivity is lowered. If a color filter is laminated on such small-capacity pixels, the photodetection sensitivity would be further lowered.

JP 2003-318375 A describes a solid-state imaging device in which one half of pixels are color detection pixels, on which color filters are laminated, and the remaining half are luminance detection pixels having no color filters. With this configuration, JP 2003-318375 improves the photodetection sensitivity of the solid-state imaging device.

If the number of pixels of a solid-state imaging device mounted on a digital camera becomes enormous, it becomes possible to capture a high-definition still image, while it becomes difficult to increase a frame rate at which a motion image is captured, to capture a smooth motion image.

In order to achieve a high frame rate, JP Hei. 11-261901 A (corresponding to U.S. Pat. No. 6,744,466) and JP 2005-278135 A (corresponding to US 2005/0195304 A) disclose that a motion image is captured by pixel skipping or a motion image is output from the solid-state imaging device by pixel coupling.

However, in the solid-state imaging device of the related art, which performs pixel skipping or pixel coupling, all of the pixels are color detection pixels. A target of the related art is not a solid-state imaging device in which a half of its pixels are luminance detection pixels.

### SUMMARY OF THE INVENTION

The invention provides a novel method for driving a solid-state imaging device that reads high sensitive image data from a solid-state imaging device in which plural luminance detection pixels and plural color detection pixels are mixedly provided, and an imaging apparatus.

According to an aspect of the invention, a solid-state imaging device includes a plurality of color detection pixels and a plurality of luminance detection pixels. The color detection pixels and the luminance detection pixels are mixed and arranged in a two-dimensional array on a surface of a semiconductor substrate. The solid state imaging device is configured to read detection signals of the color detection pixels and detection signals of the luminance detection pixels independently. A method for driving the solid-state imaging device includes independently controlling a first time period from a time when the color detection pixels start to be exposed to a time when the detection signals of the color detection pixels are read and a second time period from a time when the luminance detection pixels start to be exposed to a time when the detection signals of the luminance detection pixels are read.

Also, the first time period may be longer than the second time period.

Also, when motion image data is output from the solid-state imaging device, a first frame rate at which captured image data is read from the color detection pixels and a second frame rate at which captured image data is read from the luminance detection pixels may be differentiated from each other.

Also, the second frame rate may be higher than the first frame rate.

Also, after captured image data for a plurality of frames is successively read from the luminance detection pixels, captured image data for one frame may be read from the color detection pixels.

Also, when the captured image data is read from the color detection pixels, the reading of the captured imaged data from the luminance detection pixels may be interrupted, and data stored in the luminance detection pixels may be discarded.

Also, when the captured image data is read from the color detection pixels, the captured image data may be read from the luminance detection pixel together, and pixel skipping may apply to the reading of the color detection pixels and the reading of the luminance detection pixels.

According to another aspect of the invention, an imaging apparatus includes a plurality of color detection pixels, a plurality of luminance detection pixels, and a control unit. The color detection pixels and the luminance detection pixels are mixed and arranged in a two-dimensional array on a surface of a semiconductor substrate. The control unit is configured to read detection signals of the color detection pixels and detection signals of the luminance detection pixels independently. The control unit independently controls a first time period from a time when the color detection pixels start to be exposed to a time when the detection signals of the color detection pixels are read and a second time period from a time when the luminance detection pixels start to be exposed to a time when the detection signals of the luminance detection pixels are read.

Also, the imaging apparatus may further include an image processing unit that synthesizes captured image data being read from the color detection pixels and captured image data being read from the luminance detection pixels to generate a color image of a subject.

Also, the color detection pixels provided in the solid-state imaging device may be substantially equal in number to the luminance detection pixels.

Also, even-numbered pixel rows formed on the surface of the semiconductor substrate may be shifted by ½ pixel pitch with respect to odd-numbered pixel rows. One of the odd-numbered pixel rows and the even-numbered pixel rows may consist of the luminance detection pixels. The other of the odd-numbered pixel rows and the even-numbered pixel rows may consist of color detection pixels.

With the above configuration, high sensitive image data can be read at a high frame rate from a solid-state imaging device in which a plurality of luminance detection pixels and a plurality of color detection pixels are mixedly provided.

### BRIEF DESCRIPTION OF THE DRAWINGS

FIG. 1 is a functional block diagram of a digital camera according to an embodiment of the invention.

FIG. 2 is a schematic view of a surface of a solid-state imaging device shown in FIG. 1.

FIG. 3 is an explanatory view of pixel arrangement of the solid-state imaging device shown in FIG. 2.

FIG. 4 is a schematic timing chart illustrating a driving method for reading motion image data from the solid-state imaging device shown in FIG. 2.

FIG. 5 is a schematic timing chart illustrating a driving method according another embodiment of the invention, for reading motion image data from the solid-state imaging device shown in FIG. 2.

FIG. 6 is a schematic view of a surface of a solid-state imaging device, in which pixels are arranged in square lattice, according to still another embodiment of the invention.

FIG. 7 is a schematic view of a surface of a solid-state imaging device, in which pixels are arranged in square lattice, according to still further another embodiment of the invention.

### DETAILED DESCRIPTION OF EMBODIMENTS OF THE INVENTION

Embodiments of the invention will now be described with reference to the drawings.

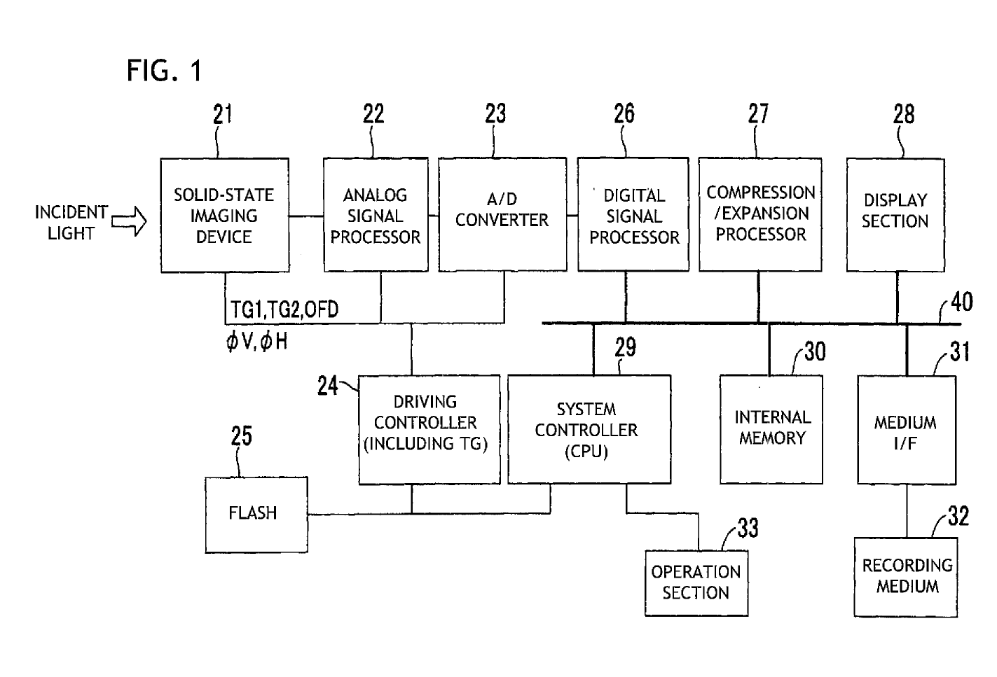

FIG. 1 is a functional block diagram of a digital camera according to an embodiment of the invention. The digital camera includes a solid-state imaging device 21, an analog signal processor 22 that performs analog processing, such as automatic gain control (AGC) and correlated double sampling, for analog image data output from the solid-state imaging device 21, an analog-to-digital (A/D) converter 23 that converts the analog image data output from the analog signal processor 22 into digital image data, a driving controller 24 (including a timing generator (TG)) that controls driving of the A/D converter 23, the analog signal processor 22, and the solid-state imaging device 21 according to a command from a system controller (CPU) 29 described later, and a flash 25 that emits light according to a command from the CPU 29.

The digital camera according to this embodiment further includes a digital signal processor 26 that receives the digital image data output from the A/D converter 23 and performs interpolation, white balance correction, gamma correction and RGB/YC conversion for the digital image data, a compression/expansion processor 27 that compresses the image data to image data of a JPEG format or expands the JPEG image data, a display section 28 that displays a menu and/or displays a through image or a captured image, a system controller (CPU) 29 that overall controls the entire digital camera, an internal memory 30 such as a frame memory, a medium interface (I/F) 31 that interfaces with a recording medium 32 for storing the JPEG image data, and a bus 40 that connects these components with each other.

An operation section 33 through which a user inputs an instruction is connected to the system controller 29. The operation section 33 includes a shutter release button and a menu operation button. The user can make selection on a menu screen to switch between an instruction to capture a motion image and an instruction to capture a still image.

When the user selects one of the instruction to capture a motion image and the instruction to capture a still image, the system controller 29 receives the selection instruction and outputs a control command to the driving controller 24. Then, the driving controller 24 drives the solid-state imaging device 21 by using transfer gate control signals (reading control signals) TG1 and TG2 and an OFD (electronic shutter) signal corresponding to the instruction to capture a motion image or the instruction to capture a still image, vertical transfer pulses φV, and a horizontal transfer pulse φH, as described in detail later.

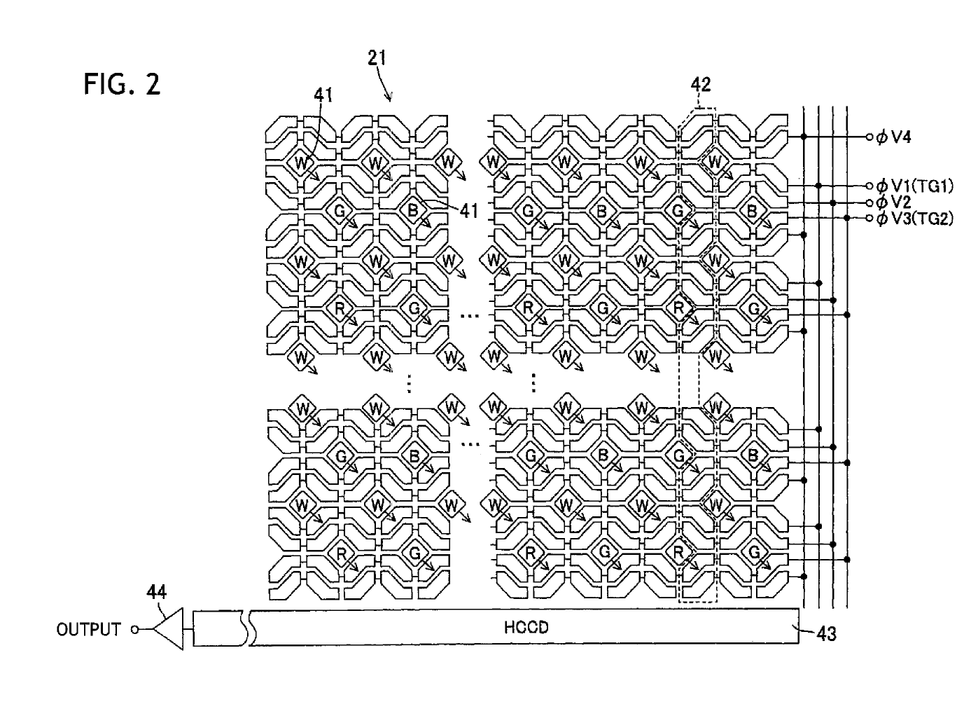

FIG. 2 is a schematic view of a surface of the solid-state imaging device 21 shown in FIG. 1. On the surface of the semiconductor substrate, a plurality of photoelectric conversion elements (photodiodes (PDs): hereinafter, may be referred to as “pixels”) 41 are arranged in a two-dimensional array.

The solid-state imaging device 21 of this embodiment has a so-called honeycomb pixel pattern in which even-numbered pixel rows are shifted by ½ pixel pitch with respect to odd-numbered pixel rows. Transparent filters for luminance detection (in FIG. 2, indicated by symbol “W” representing white) are laminated on the pixels 21 of the odd-numbered rows (or even-numbered rows), and color filters are laminated on the pixels of the even-numbered rows (or odd-numbered rows).

As for the color filters, three primary colors of red (R), green (G), and blue (B) are used. When only the pixels on which the color filters are laminated are viewed, the color filters are arranged in the Bayer pattern.

Vertical charge transfer paths (VCCD) 42 that transfers signal charges read from pixels are provided to extend vertically along respective pixel columns in a meandering manner. A horizontal charge transfer path (HCCD) 43 is provided along the ends, in a transfer direction, of the vertical charge transfer paths 42. An amplifier 44 is provided at the output end of the horizontal charge transfer path 43. The amplifier 44 outputs a voltage value signal according to an amount of the transferred charges as captured image data.

The terms “horizontal” and “vertical” used herein mean “one direction” along the surface of the semiconductor substrate and “a direction substantially perpendicular to the one direction”.

Of vertical transfer electrodes constituting the vertical charge transfer paths 42, electrodes located in the same horizontal position are electrically connected with each other) and the same pulse potential is applied to them. In the example shown in the figure, the solid-state imaging device 21 is driven in four phases. By applying vertical transfer pulses φV1 to φV4, the signal charges in the vertical charge transfer path 42 are transferred toward the horizontal charge transfer path 43.

When a transfer gate pulse voltage (read pulse voltage) TG1 is applied to transfer electrodes V1, charges accumulated in W pixels are read out into potential packets, which are formed below the electrodes V1. When a transfer gate pulse voltage TG2 is applied to transfer electrode V3s, charges accumulated in R, G, and B pixels are read out into potential packets, which are formed below the electrodes V3.

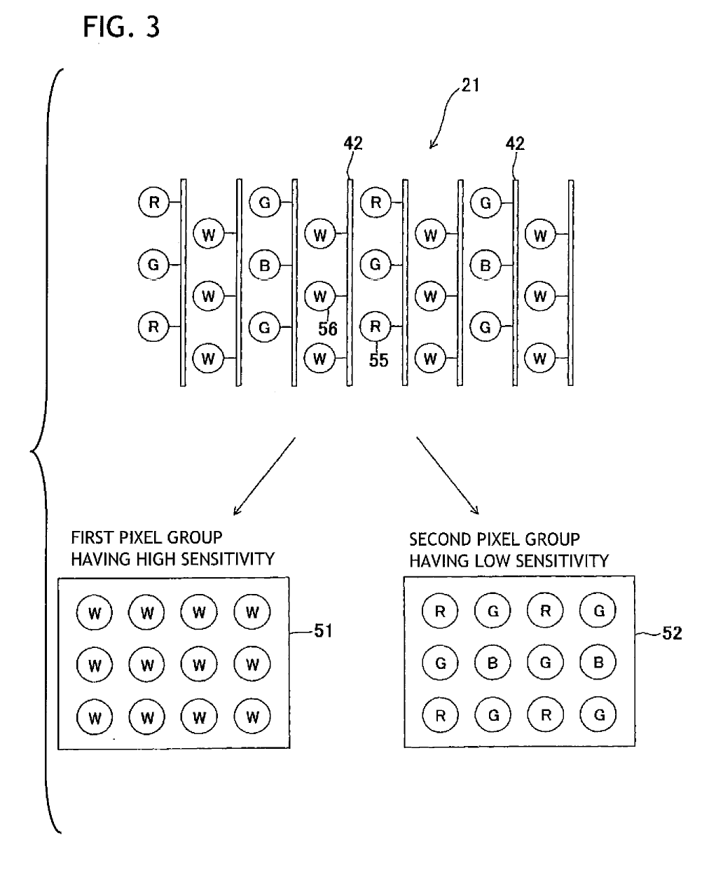

FIG. 3 is a schematic view illustrating pixel arrangement of the solid-state imaging device 21 shown in FIG. 2. The pixel arrangement of the solid-state imaging device 21 shown in FIG. 3 is configured so that a first pixel group 51 including luminance detection pixels (W pixels) being arranged in square lattice and a second pixel group 52 including color (R, G, B) detection pixels being arranged in square lattice overlap each other with being shifted by ½ pixel pitch with respect to each other in the vertical and horizontal directions.

The W pixels (luminance detection pixels) having high sensitivity, on which the entire incident light is incident, are substantially equal in number to the color detection pixels on which the color filters RGB are laminated. Therefore, the solid-state imaging device 21 has such an advantage that an S/N ratio can be enhanced while color resolution can be maintained relatively high. Also, the maximum resolution for a gray signal becomes the resolution determined by the total number of W pixels and color detection pixels.

When the user inputs the instruction to capture a still image and presses the shutter button, the solid-state imaging device 21 shown in FIG. 2 is driven in a normal way to read out a captured image signal. That is, the OFD pulse is applied to open the electronic shutter and to start exposure. Subsequently, when a shutter time period expires, the transfer gate pulse TG1 is applied to the vertical transfer electrodes V1 serving as reading electrodes, and the transfer gate pulse TG2 is also applied to the vertical transfer electrode V3 serving as reading electrodes.

Accordingly, detected charges of the W pixels and detected charges of the RGB pixels are simultaneously read out into the vertical charge transfer paths 42, and the detected charges are then transferred to the horizontal charge transfer path 43 according to the vertical transfer pulses φV1 to φV4. Then, the detected charges are transferred along the horizontal charge transfer path 43, and the captured image data is output from the output amplifier 44 as voltage value signals.

Alternatively, the transfer gate pulse TG1 may be applied to read out the detected charges of the W pixels into the vertical charge transfer paths 42, and the transfer gate pulse TG2 may be applied at a time when the detection charges are transferred by a distance corresponding to two transfer electrodes. If do so, the detected charges of the RG pixels (or GB pixels) and the detected charges of the W pixel are located in the same horizontal position, and are then transferred in the vertical direction while being arranged in one transverse line.

After the captured image data for one screen is output from the solid-state imaging device 21 and stored in the internal memory 30 shown in FIG. 1, the digital signal processor 26 performs the image processing using the data stored in the memory 30 to generate still image data of a subject.

For example, a pixel 55 shown in an upper portion of FIG. 3 is an R pixel for detecting a red signal. An amount of a green component in the position of the R pixel 55 is calculated from detection signals of G pixels around the pixel 55 by interpolation calculation. An amount of a blue component in the position of the pixel 55 is calculated from detection signals of B pixels around the pixel 55 by interpolation calculation. Furthermore, an amount of a luminance component in the position of the pixel 55 is calculated from detection signals of W pixels around the pixel 55 by interpolation calculation.

Similarly, an amount of a red component in a position of a W pixel 56 shown in the upper portion of FIG. 3 is calculated from detection signals of R pixels around the pixel 56 by interpolation calculation. An amount of a green component in the position of the W pixel 56 is calculated from detection signals of G pixels around the pixel 56 by interpolation calculation. Furthermore, an amount of a blue component in the position of the W pixel 56 is calculated from detection signals of B pixels around the pixel 56 by interpolation calculation.

In this way, the R signal component, the G signal component, the B signal component and the luminance signal component in each pixel position are calculated. Furthermore, since the pixel positions shown in FIG. 2 are arranged in the honeycomb positions, that is, in checkered-pattern positions, the R signal component, the G signal component, the B signal component and the luminance signal component in the other checkered-pattern positions where no pixels are present are calculated. Then, Y/C (luminance/chrominance) conversion is performed for the R, G, B signals, and amounts of luminance signals are corrected based on the detection signals of the luminance detection pixels, thereby obtaining still image data. If necessary, the still image data is converted into JPEG image data and is then recorded in the recording medium 32.

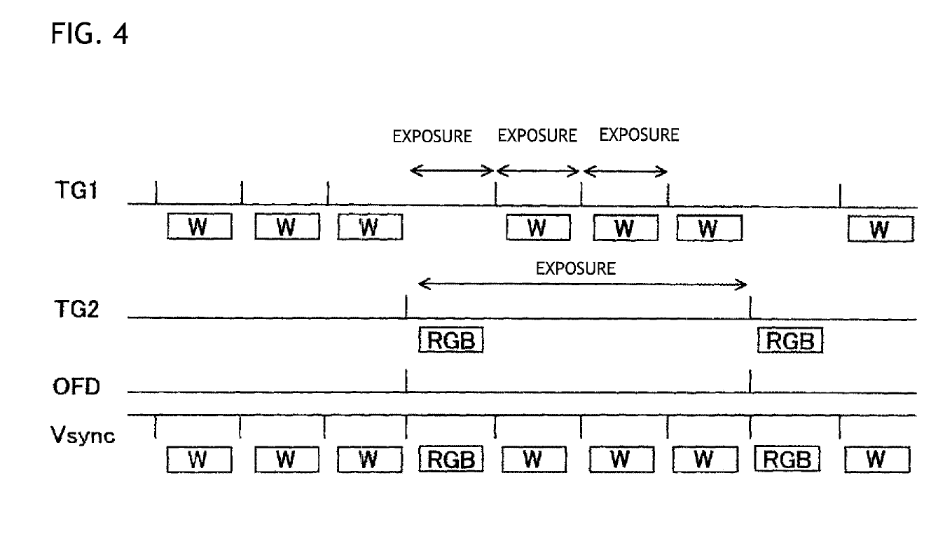

FIG. 4 is a schematic timing chart illustrating a driving method for reading motion image data from the solid-state imaging device 21 shown in FIG. 2. As shown in FIG. 3, the solid-state imaging device 21 shown in FIG. 2 may be divided into the first group 51 including the W pixels and the second group 52 including the R, G, B pixels. As shown in FIG. 2, since the transfer gate electrodes V1 for the W pixels and the transfer gate electrodes V3 for the R, G, B pixel are located in physically different positions, the W pixels and the R, G, B pixels can be read independently from each other.

Accordingly, when a motion image is read, the captured image data of the first group 51 and the captured image data of the second group 52 are read out independently from each other. In the embodiment shown in FIG. 4, the transfer gate pulse TG is applied in synchronization with a vertical synchronization signal Vsync. Specifically, after the transfer gate pulse TG2 is applied once, the transfer gate pulse TG1 is applied successively three times. Next, the transfer gate pulse TG2 is applied once, and then the transfer gate pulse TG1 is applied successively three times. This operation is repeatedly performed. At this time, the OFD pulse is applied after the transfer gate pulse TG2, so that the residual charges in each pixel (photodiode) are discharged to the substrate.

According to this method for driving the solid-state imaging device 21, the signals of the W pixels, that is, the W signals having the high sensitivity are read out from the solid-state imaging device 21 while a high frame rate is maintained. The R, G, B pixel signals having a low sensitivity are output once every four vertical synchronization signals, that is, at a low frame rate. However, since the exposure time period for the R, G, B pixels is four times longer than the exposure time period for the W pixel, high-sensitive signals can be obtained.

The digital signal processor 26 shown in FIG. 1 calculates the amounts of the R, G, B signal components in the W pixel positions based on the R, G, B signals read out from the solid-state imaging device 21 and holds the calculated amounts. Then, the digital signal processor 26 performs coloring correction for the W pixel signals output from the solid-state imaging device 21, thereby generating motion image data. When the R, G, B signals are read out from the solid-state imaging device 21, luminance correction is performed for the R, G, B signals based on the W pixel signals read out from the solid-state imaging device 21 immediately before, thereby generating motion image data.

According to this embodiment, a high frame rate can be maintained and high-sensitive motion image data can he generated.

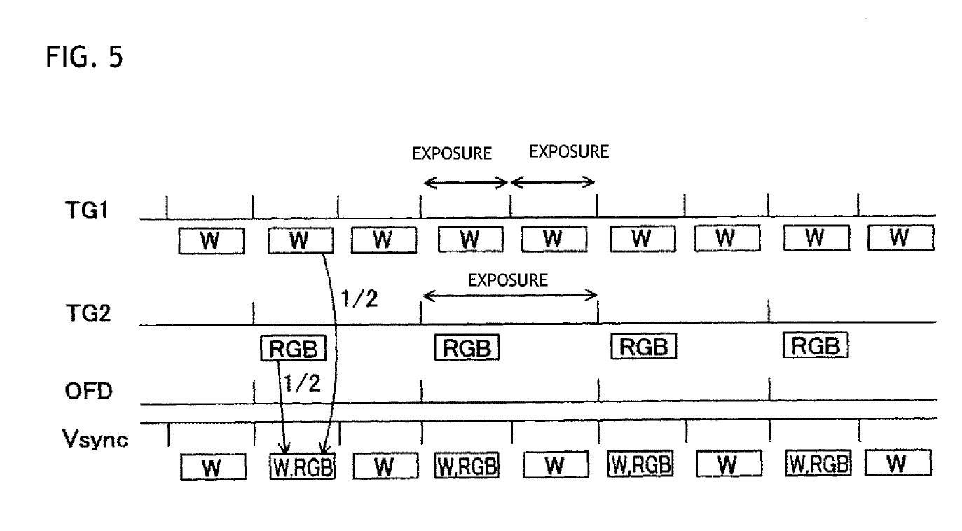

FIG. 5 is a schematic timing chart illustrating a method for driving a solid-state imaging device according to another embodiment of the invention. In this embodiment, since the transfer gate pulse TG1 is constantly applied in synchronization with the vertical synchronization signal, the W pixel signals are constantly read out from the solid-state imaging device 21. Furthermore, since the transfer gate pulse TG2 and the OFD pulse are applied once each time the transfer gate pulse TG1 is applied twice, captured image data is read out from the R, G, B pixels in which signal charges are accumulated for an exposure time period being two times longer than that for the W pixels.

In this embodiment, a frame in which W, R, G, B pixel signals are read out and a frame in which W pixel signals are read out are alternately provided. Accordingly, it is necessary to set the frame in which signals are read out only from the W pixels and the frame in which signals are read out from the W, R, G, B pixels to be equal in number of read signal to each other. For this reason, when signals are read out from the W, R, G, B pixels, the reading operation is performed while skipping ½ of the W, R, G, and B pixels.

When the W, R, G, B pixel signals are read out from the solid-state imaging device 21, a motion image for one screen is generated based on the W, R, G, B pixel signals, and the amount of color component correction by the R, G, B pixel signals is stored. Subsequently, W pixel signals which are read out from the solid-state imaging device 21 in a next frame is corrected by the amount of color component correction. Then, a motion image for a next frame is generated. This operation is repeatedly performed. In this embodiment, high-sensitive motion image data can be obtained while a high frame rate can be maintained.

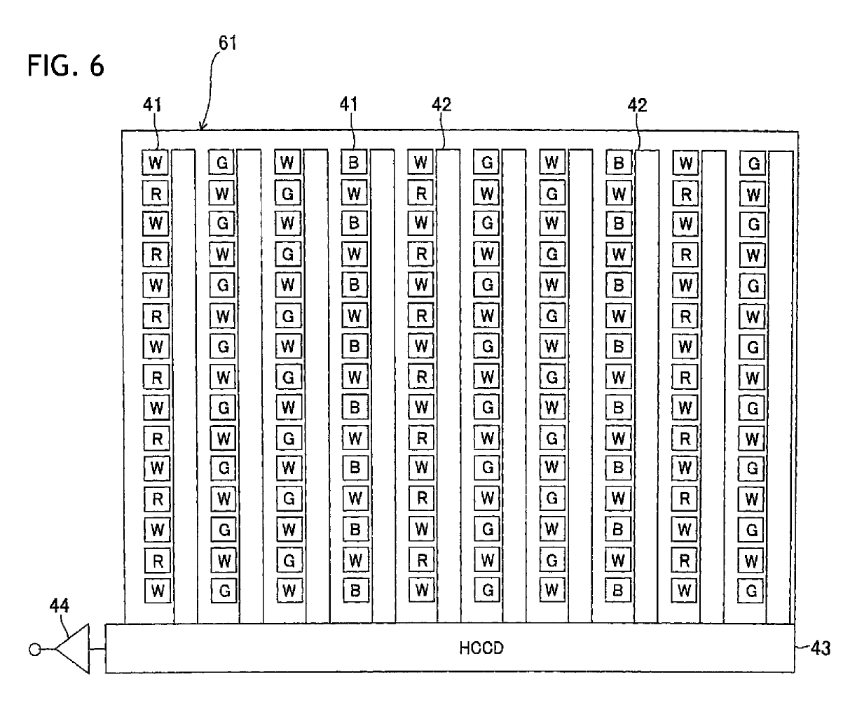

In the foregoing embodiments, the pixels of the solid-state imaging device 21 are arranged in the honeycomb pattern. However the invention may be applied to a solid-state imaging device in which pixels are arranged in square lattice. For example, in a solid-state imaging device 61 shown in FIG. 6, pixels 41 are arranged in square lattice. Here, among the pixels, pixels being located in checkered-pattern positions are luminance detection pixels (W pixels), and pixels being located in the other checkered-pattern positions are color detection pixels (R, G, B pixels).

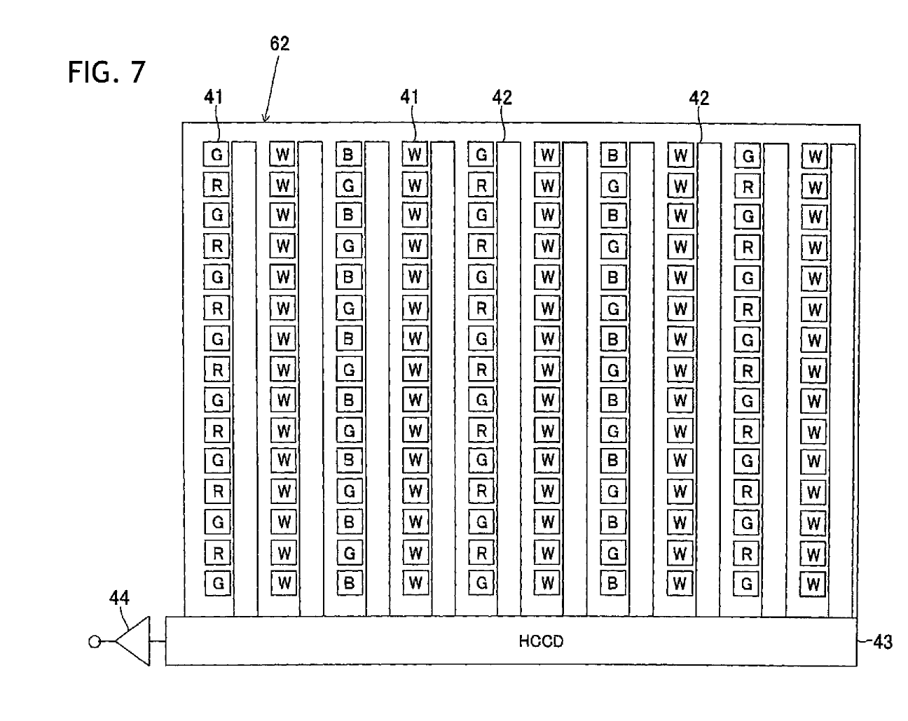

In a solid-state imaging device 62 shown in FIG. 7, pixels 41 are arranged in square lattice. Among the pixels columns, pixel columns being arranged every other column are W pixel columns, and the remaining pixel columns are color pixel columns.

In this case, it is necessary to provide the transfer gate electrodes (reading electrodes) for W pixels to be shifted with respect to the transfer gate electrodes (reading electrodes) for adjacent color (R, G, B) pixels in the horizontal direction. For example, as described in JP 2003-318375 A, the number of vertical transfer electrodes per pixel is set to be at least two, and a transfer gate electrode (reading electrode) of the two electrodes for the W pixel is differentiated from that for the adjacent color pixel in the horizontal direction. Accordingly, the foregoing embodiments can also be applied to the pixel arrangements shown in FIGS. 6 and 7.

In the foregoing embodiments, the case where a motion image is captured has been described. However, when a still image is captured, the capture image can be obtained with the exposure time period for the color detection pixels being set to be longer than that for the luminance detection pixels.

According to the method for driving the solid-state imaging device, high-sensitive captured image data can be read out from the solid-state imaging device having a large number of pixels. Therefore, this driving method is advantageously if it is applied to a digital camera or the like.

What is claimed is:

1. A method for driving a solid-state imaging device including a plurality of color detection pixels and a plurality of luminance detection pixels, wherein the color detection pixels and the luminance detection pixels are mixed and arranged in a two-dimensional array on a surface of a semiconductor substrate, and the solid state imaging device is configured to read detection signals of the color detection pixels and detection signals of the luminance detection pixels independently, the method comprising
independently controlling a first time period from a time when the color detection pixels start to be exposed to a time when the detection signals of the color detection pixels are read and a second time period from a time when the luminance detection pixels start to be exposed to a time when the detection signals of the luminance detection pixels are read.

2. The method according to claim 1, wherein the first time period is longer than the second time period.

3. The method according to claim 1, wherein when motion image data is output from the solid-state imaging device, a first frame rate at which captured image data is read from the color detection pixels and a second frame rate at which captured image data is read from the luminance detection pixels are differentiated from each other.

4. The method according to claim 3, wherein the second frame rate is higher than the first frame rate.

5. The method according to claim 4, wherein after captured image data for a plurality of frames is successively read from the luminance detection pixels, captured image data for one frame is read from the color detection pixels.

6. The method according to claim 3, wherein when the captured image data is read from the color detection pixels, the reading of the captured imaged data from the luminance detection pixels is interrupted, and data stored in the luminance detection pixels is discarded.

7. The method according to claim 3, wherein when the captured image data is read from the color detection pixels, the captured image data is read from the luminance detection pixel together, and pixel skipping applies to the reading of the color detection pixels and the reading of the luminance detection pixels are performed.

8. An imaging apparatus comprising:
a plurality of color detection pixels;
a plurality of luminance detection pixels, wherein the color detection pixels and the luminance detection pixels are mixed and arranged in a two-dimensional array on a surface of a semiconductor substrate; and
a control unit configured to read detection signals of the color detection pixels and detection signals of the luminance detection pixels independently, wherein
the control unit independently controls a first time period from a time when the color detection pixels start to be exposed to a time when the detection signals of the color detection pixels are read and a second time period from a time when the luminance detection pixels start to be exposed to a time when the detection signals of the luminance detection pixels are read.

9. The imaging apparatus according to claim 8, further comprising:
an image processing unit that synthesizes captured image data being read from the color detection pixels and captured image data being read from the luminance detection pixels to generate a color image of a subject.

10. The imaging apparatus according to claim 8, wherein the color detection pixels provided in the solid-state imaging device is substantially equal in number to the luminance detection pixels.

11. The imaging apparatus according to claim 10, wherein
even-numbered pixel rows formed on the surface of the semiconductor substrate are shifted by ½ pixel pitch with respect to odd-numbered pixel rows,
one of the odd-numbered pixel rows and the even-numbered pixel rows consist of the luminance detection pixels, and
the other of the odd-numbered pixel rows and the even-numbered pixel rows consist of color detection pixels.
